(19) United States
(12) Patent Application Publication
(10) Pub. No.: US 2025/0198812 A1
(43) Pub. Date: Jun. 19, 2025

(54) SENSOR EVALUATION

(71) Applicant: BRITISH TELECOMMUNICATIONS PUBLIC LIMITED COMPANY, London, Greater London (GB)

(72) Inventors: Ian THURLOW, London, Greater London (GB); Ian NEILD, London ,Greater London (GB)

(21) Appl. No.: 18/849,288

(22) PCT Filed: Feb. 27, 2023
(86) PCT No.: PCT/EP2023/054794

§ 371 Date: Sep. 20, 2024

(30) Foreign Application Priority Data
Mar. 24, 2022 (GB) 2204150.3

(51) Int. Cl. G01D 18/00; B64U 40/00; B64U 101/00; G01D 11/30

(52) U.S. Cl. CPC G01D 18/006; B64U 40/00; G01D 11/30; B64U 2101/00

(57) ABSTRACT

A method, an unmanned mobile entity and a computer program are provided for evaluating a performance of a first sensor unit which is arranged to measure a physical property of its environment at a location. An unmanned mobile entity transports a reference sensor unit to the location and the reference sensor unit is arranged to measure the physical property at the location. The performance of the first sensor unit is evaluated based on a comparison of the measurements of the first and reference sensor units.

### FIELD

The present disclosure relates to a method of sensor evaluation.

More specifically, it relates to a method of evaluating the performance of a sensor unit which is arranged to measure a physical property.

### BACKGROUND

A wide range of sensors are deployed in numerous smart cities and Internet of Things (IoT) projects worldwide. Examples include sensors for monitoring air quality, relative humidity, wind speed, and road surface temperature to name but a few. It is common practice to mount sensors on local authority assets such as streetlamp columns or various building structures, with the data generated by those sensors used for subsequent monitoring, analysis and processing. Sensors can also be placed in remote locations that are difficult or not practical to access easily. As the cost of deploying thousands of sensors across a smart city type project can be significant, it is common to deploy lower cost, and possibly lower quality, sensors on a wide scale.

Sensor data collected from such lower-cost sensors in typical IoT or smart cities type deployments will be subject to drift and other forms of change over time and can consequently lead to changes or inaccuracies in the measurements and may adversely influence any analysis or decision making made on the basis of that data.

With the explosion of use of IoT devices and lower costs for sensors, IoT sensors will be deployed on an immense scale in the future. It is not feasible in terms of time and cost for maintenance operators to visit the sites of thousands or tens of thousands of field-based sensors across a wide geographic area to repair or replace them. In many cases the sensors may be located in difficult to reach locations, or need specialised equipment, which would incur additional costs.

### SUMMARY

According to a first aspect of the present disclosure, there is accordingly provided a method of evaluating a performance of a first sensor unit arranged to measure a physical property of its environment at a location, the method comprising:
an unmanned mobile entity transporting a reference sensor unit to the location, the reference sensor unit being arranged to measure the physical property at the location; and
evaluating a performance of the first sensor unit based on a comparison of measurements of the first and reference sensor units.

Preferably, the reference sensor unit is arranged to measure the physical property in the vicinity of the first sensor unit.

Preferably, the step of comparing measurements of the reference sensor unit and the first sensor unit is based on matching portions of respective measurements of each sensor unit.

Preferably, the measurements comprise average measurements, preferably over a defined time period.

Preferably, the method further comprises receiving the measurements of the first sensor unit; and, responsive to an evaluation that the performance of the first sensor unit does not meet a defined threshold value, updating the received measurements with offset data that are based on at least some of the corresponding measurements of the reference sensor unit.

Preferably, wherein responsive to the reference sensor unit being removed from the location of the first sensor unit, the method further comprises continuing to update the received measurements with offset data that are based on at least some of the corresponding measurements of the reference sensor unit prior to being removed.

Preferably, the method further comprises calibrating the first sensor unit by updating software or installing new software so as to offset a determined difference between the measurements of the first and reference sensor units.

Preferably, the unmanned mobile entity either remains at the location of the first sensor unit while measuring the physical property with the reference sensor unit, or the unmanned mobile entity is arranged to drop off the reference sensor unit at the location of the first sensor unit for measuring the physical property and optionally returns to remove the reference sensor unit from said location.

Preferably, the calibration of the first sensor unit is arranged to take place while the unmanned mobile entity remains at the location of the first sensor unit while storing the measurements and the method further comprises transferring the software update or the software from the reference sensor unit or the unmanned mobile entity to the first sensor unit.

Preferably, the method further comprises removing the first sensor unit to a remote location for calibration; and optionally returning the first sensor unit after it has been calibrated.

Preferably, the method further comprises transferring the measurements of the first sensor unit to the reference sensor unit or to the unmanned mobile entity.

Preferably, the method further comprises transferring the measurements of the reference sensor unit and the first sensor unit to a separate processing unit which is arranged to evaluate the performance of the first sensor unit based on said comparing of measurements.

Preferably, the separate processing unit is comprised in a remote server module.

Preferably, the method further comprises replacing the first sensor unit with another sensor unit.

Preferably, the reference sensor unit comprises several sensor units which are arranged to measure the same physical property as the first sensor unit.

Preferably, the offset data have been determined by using machine learning techniques which are based on historical measurements of reference sensor units.

Preferably, the unmanned mobile entity is an unmanned aerial vehicle.

According to a second aspect of the present disclosure, there is a provided an unmanned mobile entity which is arranged to carry out the steps of the method set out above.

According to a third aspect of the present disclosure, there is a provided a computer program element comprising computer program code to, when loaded into a computer system and executed thereon, cause the computer to perform the steps of the method set out above.

### BRIEF DESCRIPTION OF THE FIGURES

In order that the present disclosure may be better understood, examples thereof will now be described, by way of example only, with reference to the accompanying drawings in which:

FIG. 1a schematically illustrates an example of the main components of one disclosure;

FIG. 1b shows an un-manned aerial vehicle;

FIG. 1c schematically illustrates an example of another disclosure; and

FIG. 2 is a flowchart of a method of evaluating a performance of a first sensor unit arranged to measure a physical property of its environment at a location in accordance with the present disclosure.

### DETAILED DESCRIPTION OF EXAMPLES

Examples of the present disclosure will now be described, by way of example only, with reference to the accompanying drawings.

Conventionally, different solutions or methods are being employed to deal with the issue of managing potentially faulty and drifting sensors. One way is to just let it be and eventually stop using the captured measurements. Another way is to repair it but that would interrupt the data capturing during the repairing. Low-cost sensors aren't worthwhile repairing. Normally, the faulty sensor is taken back to a service centre causing an interruption that may last many days. Alternatively, it is possible to replace the flawed sensor with another sensor. Repairing or replacing the sensor requires workforce personnel on site, and, often specialised equipment is required to access, for example, a hoist vehicle. With sensors commonly mounted on street lighting columns, temporary roadworks may need to be put in place to protect operatives from road traffic, which may disrupt the traffic flow.

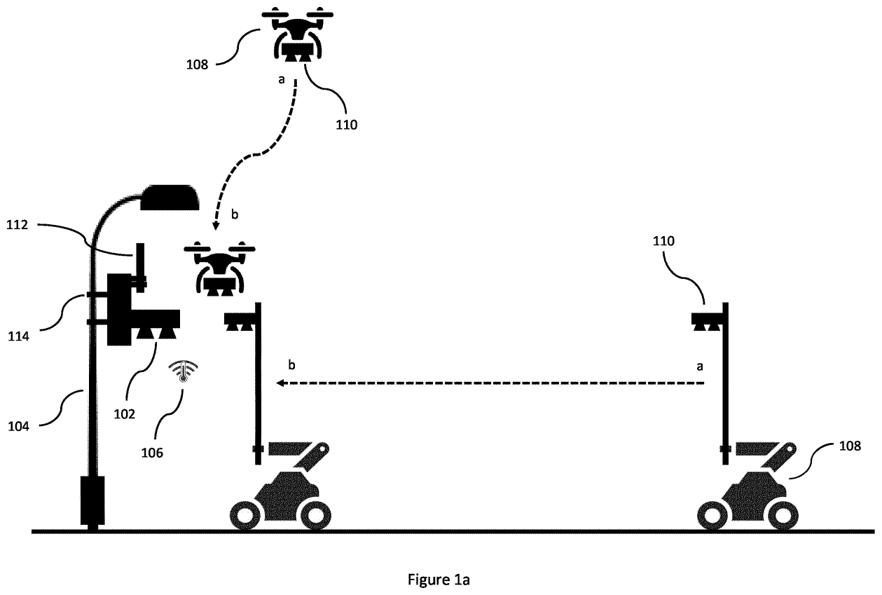

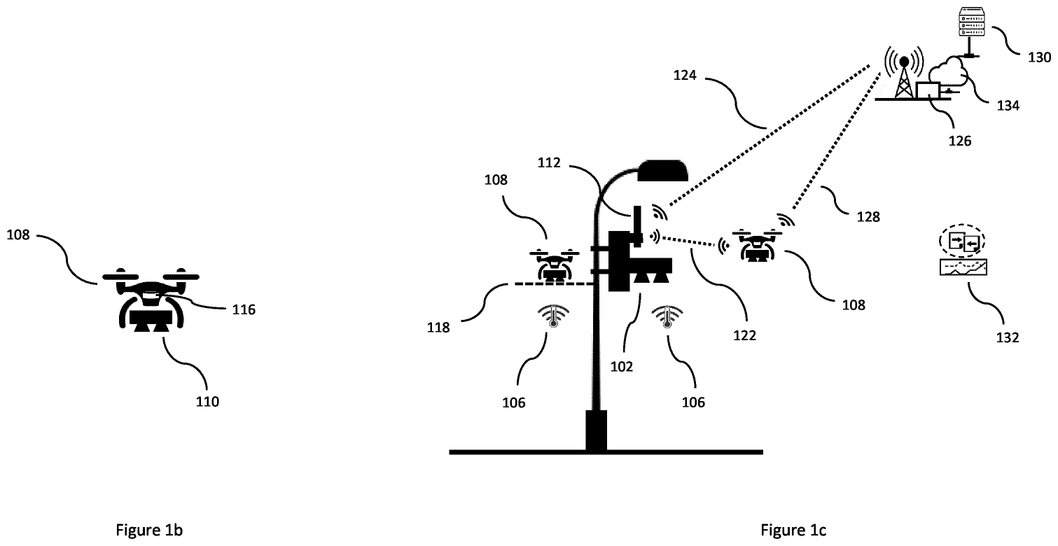

FIG. 1 schematically illustrates an example of the main components of one disclosure. A first sensor unit 102 is mounted on a street pole 104, optionally via a mounting construction 114, and is arranged to measure a physical property 106 at the location of the street pole. For example, the sensor unit 102 can include one or more sensors for monitoring one or more of air quality, relative humidity, wind speed, and/or road surface temperature. Over time, the sensors can degrade and the measurements of the physical property may start drifting and/or report distorted data. An unmanned mobile entity 108, such as an unmanned aerial vehicle, e.g., a drone, or an unmanned ground vehicle, such as a service robot, can transport a reference sensor unit 110 from a point a), different to the location of the first sensor unit 102, to a point b) at the same location as the first sensor unit 102 is stationed. The reference sensor can then measure the same physical property as the first sensor unit 102 and compare respective measurements and thus evaluate the performance of the first sensor unit 102. The first sensor unit 102 preferably communicates the captured measurements using any kind of suitable wireless/cellular and/or wired technology. Optionally, a transceiver 112 or the like is employed for transmitting and receiving data. The reference sensor unit 110 and/or the unmanned mobile entity 108 may have corresponding transceivers.

This method is very advantageous in many ways and a distinct improvement over existing solutions deployed on the market or described in literature. By instead having a reference sensor transported to the site of the IoT sensor to capture the corresponding physical properties as the IoT sensor does and compare the data, it is possible to quickly evaluate how well the IoT sensor is functioning and then potentially take whatever proper action is desired and required. This method takes a fraction of the time and costs compared to any conventional method. By employing unmanned vehicles, such as drones, for this purpose, they can cover considerably more testing sites than a traditional crew and no interruption of traffic or hoist vehicle are needed. There is also no interruption of the IoT sensor capturing the measurements of the physical property. The method according to this disclosure thus makes the evaluation of lower cost field-based sensors a cost-saving and technically advantageous proposition.

The comparison of the measurements of the first sensor unit 102 and the reference sensor unit 110 may take place in different ways. FIG. 1b shows an unmanned mobile entity 108 carrying a reference sensor unit 110. The unmanned mobile entity 108 preferably comprises processing means 116 and memory means (not shown) to process, for example, comparison of physical properties data received from the first sensor unit 102 and the reference sensor unit 110. The processing means 116 and memory means may alternatively be comprised in the reference sensor unit 110 itself or they may be distributed between the unmanned mobile entity 108 and the reference sensor unit 110.

FIG. 1c schematically illustrates an example of another disclosure. When an unmanned mobile entity 108 arrives with the reference sensor unit 110 at a location for the purposes of evaluating the performance of a first sensor unit 102, it may collect measuring data of the physical property in different ways. One way is to collect the data while the unmanned mobile entity 108 remains at the location of the first sensor unit 102, for example, while hovering in the air or on the ground. The unmanned mobile entity 108 may also land on a platform 118 which is suitable to facilitate a landing of an unmanned aerial mobile entity 108. The platform 118 may already exist for other purposes when technical personnel are carrying out repair or service work, or a proprietary platform may be built to provide a suitable landing site. Additionally, and alternatively, the unmanned mobile entity 108 may be detachably connected to a fixed object at the location of the first sensor unit 102, for example, a lamp post, a pole, or any kind of rigid structure to secure it against harsh weather conditions and theft. The detachable connection may be magnetic, including an electromagnetic connection. Alternatively, the unmanned mobile entity 108 may drop off the reference sensor unit 110 at the location of the first sensor unit 102 and return later to collect the reference sensor unit 110.

The reference sensor unit 110 may likewise connect with a detachable connection to secure it.

Optionally, the measurements of the first sensor unit 102 are transferred 122 to the reference sensor unit 110 or to the unmanned mobile entity 108, and the evaluation of the first sensor unit 102 can take place in either of them. Alternatively, the measurements of the first sensor unit 102 are transferred 124 to a separate processing unit 126, and the measurements of the reference sensor unit 110 are separately transferred 128 to the separate processing unit 126, which processing unit 126 is arranged to evaluate the performance of the first sensor unit 102 based on said comparing of measurements 132. Alternatively, the separate processing unit is comprised in a remote server module 130 where the comparison of measurements 132 takes place. Conventional wireless or wired communication means are deployed to transfer the respective measurements from the sensor units. The internet 134 may be used in any link. Alternatively, the unmanned mobile entity 108 can first move to another location, for example, to a proprietary data collection point, or to its regular service station, before transferring the measurements of the physical property from either reference sensor unit 110 or from both the reference sensor unit 110 and the first sensor unit 102. The separate processing unit 126 may be located at the premises of the service station or may be located in a different location. The comparison 132 may either way take place once both measurements have been collected by either the separate processing unit 126 or the remote server module 130.

The evaluation process of the performance of the first sensor unit 102 by comparing the measurements 132 of the reference sensor unit 110 with the first sensor unit 102 will hereinafter be described. As described earlier, the comparison 132 can take place directly at the in the reference sensor unit 110 or in the unmanned mobile entity 108 at the location of the first sensor unit 102, depending upon where the processing means are located, or they may take place directly, in the separate processing unit 126 or in the remote server module 130, or later, after the unmanned mobile entity 108 has transferred the measurements at a location different from the location of the first sensor unit 102, also in the separate processing unit 126 or in the remote server module 130.

Preferably, the comparing of measurements of the reference sensor unit 110 and the first sensor unit 102 is based on matching portions of respective measurements of each sensor unit. By matching portions is meant that portions of each measurement relate to substantially the same time frame. The captured physical properties can quickly vary a lot, so it is preferred to have measurements from the same time period and of similar data length. Preferably, the measurements are average measurements over a certain time period so as to achieve more robust data which is less affected by temporary, unusual fluctuations in the captured data.

The outcome of the evaluation process may result in various options if the performance of the first sensor unit 102 does not meet a defined threshold value, such as a minimum threshold measure or rating of performance. The various options comprise offsetting the measurements of the first sensor unit 102, repairing the first sensor unit 102, calibrating the first sensor unit 102 by updating its software or installing new software in it or replacing the first sensor unit 102. The latter options may take place while the unmanned mobile entity 108 remains at the location of the first sensor unit 102 or they may take place later, after the unmanned mobile entity 108 has transferred the measurements at a location different from the location of the first sensor unit 102.

One fast response involves updating the received measurements of the first sensor unit 102 with offset data that are based on at least some of the corresponding measurements of the reference sensor unit 110. If the performance of the first sensor unit 102 is poor, e.g., below a defined threshold measure of performance, the measurements of the first sensor unit 102 may not represent reliable values. By then updating them with corresponding measurements of the reference sensor unit 110, the captured data will represent values that are more reliable. The updating and offsetting procedure may be done in different ways. An offset signal, or offset data, may be sent to the first sensor unit 102 to offset the hereinafter generated measurements with for example 3° C. or −4° C. This may continue until the first sensor unit 102 has been updated with new software or until it has been replaced or repaired. The offset signal, or offset data, may be sent from one of: reference sensor unit 110, unmanned mobile entity 108, separate processing unit 126 and remote server module 130 in response to the outcome of the evaluation process. The sending of the offset signal, and the comparison of measurements 132 of the reference sensor unit 110 and the first sensor unit 102 may take place in the same unit or module but they may also take place in different units or modules. For example, the comparison 132 may take place in the reference sensor unit 110, and the results may be sent to the remote server module 130 which then sends the offset signal to the first sensor unit 102. Or the comparison 132 may take place in the separate processing unit 126 which implements the offset therein. Alternatively, the offset signal may instead be sent to the separate processing unit 126, or to the remote server module 130, to offset the hereinafter generated measurements. The measurements sent from the first sensor unit 102 will thus continue to be faulty but they will be offset and corrected in the separate processing unit 126 or in the remote server module 130, wherever the offset process takes place.

Furthermore, there may not necessarily be a specific offset signal, or offset data, sent to the first sensor unit 102, the separate processing unit 126 or to the remote server module 130. Instead, after a determination that the measurements from the first sensor unit 102 need to be offset, the memory unit with the dataset or repository containing the faulty measurements are simply updated by adding or subtracting the offset data to reflect the correct measurements of the first sensor unit 102.

By updating the received measurements of the first sensor unit 102 with offset data in the various ways described above, it is thus possible to achieve a method which responds to and corrects faulty data exceptionally fast compared to conventional methods. An unmanned aerial mobile entity 108 may cover many such IoT sensors per day, e.g., over one hundred such sensors. In some cases, it will be necessary to ensure the entity 108 can charge while, during or between capturing the measurements. This is far superior to how it works today. Assuming most IoT sensors are located high up on lamp posts, traffic posts or tall buildings, manned personnel can only reach a fraction of what an unmanned aerial mobile entity can do. And, even then, the personnel will not offset the measurements but will instead simply replace the sensor. However, the decision to replace IoT sensors will very unlikely be based on a specific comparison test carried out at a specific location, but will, for cost-saving purposes, instead be based on a general decision to replace all IoT sensors older than a certain age, or even all sensors in a certain geographical area.

It was earlier described that the unmanned mobile entity 108 may drop off the reference sensor unit 110 at the location of the first sensor unit 102 and return later to collect it. This is advantageous for cases when the collection of the measurements of the first sensor unit 102 may need to be done over a longer time period, such as a few hours or a few days. The decision to offset the faulty measurements of the first sensor unit 102 may be immediate, or may be later, irrespective of how long the reference sensor unit 110 stays at the location of the first sensor unit 102. Also, the decision to offset data may be taken more than once during the capturing of the measurements. Furthermore, responsive to the reference sensor unit 110 being removed from the location of the first sensor unit 102, the received measurements may continue to be updated with offset data that are based on at least some of the corresponding measurements of the reference sensor unit 110 prior to being removed. So, the use of offset data is not only applied during the short or long process of capturing of the measurements of the first sensor unit 102 but continues after the reference sensor unit 110 is removed from the location of the first sensor unit 102, usually done by the unmanned mobile entity 108. The offset process may need to be applied for a long time, even for months or years. It may be a cost-saving decision to not repair or replace the IoT sensors but instead just rely on the use of offset data. The method according to the present disclosure may be repeated several times during the lifetime of an IoT sensor, each time having maybe having different offset data applied depending upon how much the measurements of the first sensor unit 102 have drifted.

Alternatively, instead of applying offset data, the first sensor unit 102 may be calibrated by updating its software or installing new software therein so as to offset a determined difference between the measurements of the first 102 and reference sensor units 110. Updating the software or installing new software in the first sensor unit 102 may likewise take place while the unmanned mobile entity 108 remains at the location of the first sensor unit 102, or they may take place later, after the unmanned mobile entity 108 has transferred the measurements at a location different from the location of the first sensor unit 102, for example, when returning to the service station of the reference sensor unit 110 or of the unmanned mobile entity 108. The software update or the software may be transferred from the reference sensor unit 110 or the unmanned mobile entity 108 to the first sensor unit 102. It is likewise also possible to update the software or install new software in the separate processing unit 126 or in the remote server module 130 so as to offset a determined difference between the measurements of the first 102 and reference sensor units 110

Instead of having only one reference sensor unit 110 it is also possible to use several reference sensor units to gain even more reliable measurements at the location of the first sensor unit 102. An average value may be used or, if the measurements of one of the reference sensor units deviates a lot, it may be discarded. The reference sensor unit 110 may be one or more suitably calibrated gold-standard reference sensors to further increase the quality of the measurements. In the case of having two or more sensors of the same type, it may the advantageous to apply machine learning to the measurements generated by the reference sensors to get an improved estimate for the true reading. Suitable machine-learning algorithms may be applied when comparing time series sensor data from the IoT sensor with time series data collected from the reference sensors over a corresponding or synchronised time period with the aim of making subsequent adjustments that correct for sensor drift or change.

Alternatively, machine-learning may also be applied when using only a single reference sensor unit 110. By collecting and analysing historical measurements of thousands of single or multiple IoT sensors over a longer time period, certain behavioural patterns, such as drift, may be determined. Instead of, for example, applying a fixed offset value between measurements of the IoT sensor, the offset value could change gradually, in accordance with the predicted machine-learning data. Seasonal changes and impact of certain weather phenomena, such as lots of rain and wind, or an unusually warm winter, may affect the machine-learning data and consequently the foreseen IoT sensor drift.

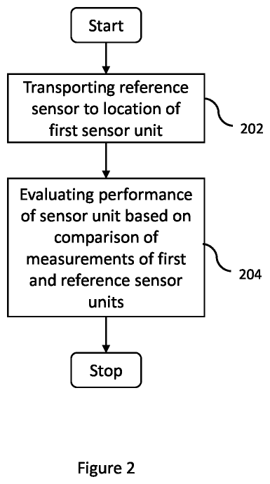

FIG. 2 is a flowchart of a method of evaluating a performance of a first sensor unit arranged to measure a physical property of its environment at a location in accordance with the present disclosure. At step 202, a reference sensor is transported to the location of the first sensor unit by an unmanned mobile entity. The reference sensor is arranged to measure the physical property at the location. Subsequently, at step 204, a performance of the first sensor unit is evaluated based on a comparison of measurements of the first and reference sensor units.

Embodiments of the invention will be apparent to those skilled in the art from consideration of the specification. It is intended that the specification be considered as exemplary only.

Where this application lists one or more method steps, the presence of precursor, follow-on and intervening method steps is not excluded unless such exclusion is explicitly indicated. Similarly, where this application lists one or more components of a device or system, the presence of additional components, whether separate or intervening, is not excluded unless such exclusion is explicitly indicated.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The scope of the present invention includes any novel features or combination of features disclosed herein. The applicant hereby gives notice that new claims may be formulated to such features or combination of features during prosecution of this application or of any further applications derived therefrom. In particular, with reference to the appended claims, features from dependent claims may be combined with those of the independent claims and features from respective independent claims may be combined in any appropriate manner and not merely in the specific combinations enumerated in the claims.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. Such a computer program may be embodied as source code or undergo compilation for implementation on a processing device, apparatus or system or may be embodied as object code, for example.

Such a computer program may be encoded as executable instructions embodied in a carrier medium, non-transitory computer-readable storage device and/or a memory device in machine or device readable form, for example in volatile memory, non-volatile memory, solid-state memory, magnetic memory such as disk or tape, optically or magneto-optically readable memory such as magnetic tape, compact disk (CD), digital versatile disk (DVD) or other media that are capable of storing code and/or data. Such a computer program may alternatively or additionally be supplied from a remote source embodied in a communications medium such as an electronic signal, radio frequency carrier wave or optical carrier wave. Such carrier media are also envisaged as aspects of the present invention.

Such instructions, when executed by a processor (or one or more computers, processors, and/or other devices) may cause the processor (the one or more computers, processors, and/or other devices) to perform at least a portion of the methods described herein.

Where a processor is referred to herein, this is to be understood to refer to a single processor or multiple processors operably connected to one another. Similarly, where a memory is referred to herein, this is to be understood to refer to a single memory or multiple memories operably connected to one another.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, smartphones, tablets, network personal computers (PCs), minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

Receivers and transmitters as described herein may be standalone or may be comprised in transceivers. A communication link as described herein comprises at least one transmitter capable of transmitting data to at least one receiver over one or more wired or wireless communication channels. Wired communication channels can be arranged for electrical or optical transmission. Such a communication link can optionally further comprise one or more relaying transceivers.

1. A method of evaluating a performance of a first sensor unit arranged to measure a physical property of its environment at a location, the method comprising:
an unmanned mobile entity transporting a reference sensor unit to the location, the reference sensor unit being arranged to measure the physical property at the location; and
evaluating a performance of the first sensor unit based on a comparison of measurements of the first and reference sensor units.

2. The method of claim 1, wherein the reference sensor unit is arranged to measure the physical property in the vicinity of the first sensor unit.

3. The method of claim 1, wherein the step of comparing measurements of the reference sensor unit and the first sensor unit is based on matching portions of respective measurements of each sensor unit.

4. The method of claim 1, wherein the measurements comprise average measurements, preferably over a defined time period.

5. The method of claim 1, further comprising:
receiving the measurements of the first sensor unit; and, responsive to an evaluation that the performance of the first sensor unit does not meet a defined threshold value,
updating the received measurements with offset data that are based on at least some of the corresponding measurements of the reference sensor unit.

6. The method of claim 5, wherein, responsive to the reference sensor unit being removed from the location of the first sensor unit, the method further comprising:
continuing to update the received measurements with offset data that are based on at least some of the corresponding measurements of the reference sensor unit prior to being removed.

7. The method of claim 1, the method further comprising:
calibrating the first sensor unit by updating software or installing new software so as to offset a determined difference between the measurements of the first and reference sensor units.

8. The method of claim 1, wherein the unmanned mobile entity either remains at the location of the first sensor unit while measuring the physical property with the reference sensor unit, or the unmanned mobile entity is arranged to drop off the reference sensor unit at the location of the first sensor unit for measuring the physical property and optionally returns to remove the reference sensor unit from said location.

9. The method of claim 8, wherein the calibration of the first sensor unit is arranged to take place while the unmanned mobile entity remains at the location of the first sensor unit while storing the measurements, and the method further comprises:
transferring the software update or the software from the reference sensor unit or the unmanned mobile entity to the first sensor unit.

10. The method of claim 7, further comprising:
removing the first sensor unit to a remote location for calibration; and optionally
returning the first sensor unit after it has been calibrated.

11. The method of claim 1, further comprising:
transferring the measurements of the first sensor unit to the reference sensor unit or to the unmanned mobile entity.

12. The method of claim 1, further comprising:
transferring the measurements of the reference sensor unit and the first sensor unit to a separate processing unit which is arranged to evaluate the performance of the first sensor unit based on said comparing of measurements.

13. The method of claim 12, wherein the separate processing unit is comprised in a remote server module.

14. The method of claim 1, further comprising:
replacing the first sensor unit with another sensor unit.

15. The method of claim 1, wherein the reference sensor unit comprises several sensor units which are arranged to measure the same physical property as the first sensor unit.

16. The method of claim 6, wherein the offset data have been determined by using machine learning techniques which are based on historical measurements of reference sensor units.

17. The method of claim 1, wherein the unmanned mobile entity is an unmanned aerial vehicle.

18. An unmanned mobile entity which is arranged to carry out the method as claimed in claim 1.

19. A computer program element comprising computer program code to, when loaded into a computer system and executed thereon, cause the computer to perform the steps of a method as claimed in claim 1.
